(19) United States
(12) Patent Application Publication
(10) Pub. No.: US 2009/0125133 A1
(43) Pub. Date: May 14, 2009

(54) COMPONENT ARCHITECTURE

(76) Inventor: Edward Balassanian, Bellevue, WA (US)

Correspondence Address: BLACK LOWE & GRAHAM, PLLC, 701 FIFTH AVENUE, SUITE 4800, SEATTLE, WA, 98104, US

(21) Appl. No.: 11/933,179

(22) Filed: Oct. 31, 2007

Related U.S. Application Data
(63) Continuation of application No. 10/775,550, filed on Apr. 12, 2006.
Application No. 10/775,550 is a continuation of application No. 10/442,402, filed on May 21, 2003, now abandoned.
Application No. 10/442,402 is a continuation of application No. 10/238,982, filed on Sep. 10, 2002, now abandoned.
Application No. 10/238,982 is a continuation of application No. 10/118,587, filed on Apr. 8, 2002, now abandoned.
(60) Provisional application No. 60/282,100, filed on Apr. 6, 2001.

(51) Int. Cl. G06F 17/00

(52) U.S. Cl. 700/94

(57) ABSTRACT

An audio server system for streaming audio content has an audio switch that receives commands from an audio control component and sends commands to an audio stream source, that receives events from an audio stream source and sends events to an audio browse list component, and that controls the switching of audio from the audio stream source to one or more receivers; and an audio control component that receives commands from an audio control synchronous component and sends commands to the audio switch.

### CROSS REFERENCES TO RELATED APPLICATIONS

This application is a continuation of and incorporates by reference in its entirety U.S. patent application Ser. No. 10/775,550 filed Feb. 10, 2004, which is a continuation of U.S. application Ser. No. 10/442,402 filed May 22, 2003 which is a continuation of U.S. application Ser. No. 10/238,982 filed Sep. 10, 2002 which is a continuation of U.S. patent application Ser. No. 10/118,587 filed Apr. 8, 2002 which claims the benefit of U.S. Provisional Application No. 60/282,100 filed Apr. 6, 2001. All applications above herein incorporated by reference in their entirety.

### FIELD OF THE INVENTION

The present invention is directed to a component architecture involved with streaming audio content.

### SUMMARY OF THE INVENTION

An audio server system for streaming audio content is disclosed. The audio server system includes an audio switch that receives commands from an audio control component and sends commands to an audio stream source that receives events from an audio stream source and sends events to an audio browse list component. The audio browse list component controls the switching of audio from the audio stream source to one or more receivers. The audio control component receives commands from an audio control synchronous component and sends commands to the audio switch.

Embodiments of the architecture include components designed to stream audio from a given audio content server PC to multiple connected audio receivers, is made up of a collection of components, i.e. Beads, communicate through command requests and event responses. The architecture is made up features which can be distributed in any way across hosts in the network under circumstances in which at most one instance of a given feature can be running on a host at a time. The features that make up the architecture are the Server, Receiver and Browser. The server features can be further broken down to support local content, Internet content or local support and Internet content. Computer executable instructions denoted as “Heartbeat” is responsible for discovering all features and forwarding corresponding events appropriately. Heartbeat includes subsets of computer executable instructions denoted as AudioBrowserList, AudioContentList, and AudioReceiverList. AudiobrowserList is configured to receive events for the Browser features, AudioContentList is configured to receive events for the Server features, and AudioReceiverList is configured to receive events for features of the Receiver.

### BRIEF DESCRIPTION OF THE DRAWINGS

FIG. 1 illustrates an audio streaming component architecture overview and the links between those components; and

FIGS. 2-4 illustrates three screen shots images from an early version of BeComm's Audio Browser.

### DETAILED DESCRIPTION OF THE PARTICULAR EMBODIMENTS

Design Overview. Embodiments described herein include a Vulcan product which is designed to stream audio from a given audio content server PC to multiple connected audio receivers, is made up of a collection of components, i.e. Beads, which will communicate through command requests and event responses. This design will outline the structure of all commands and events in the system. In addition, the structure of any required protocol initialization files will also be designed.

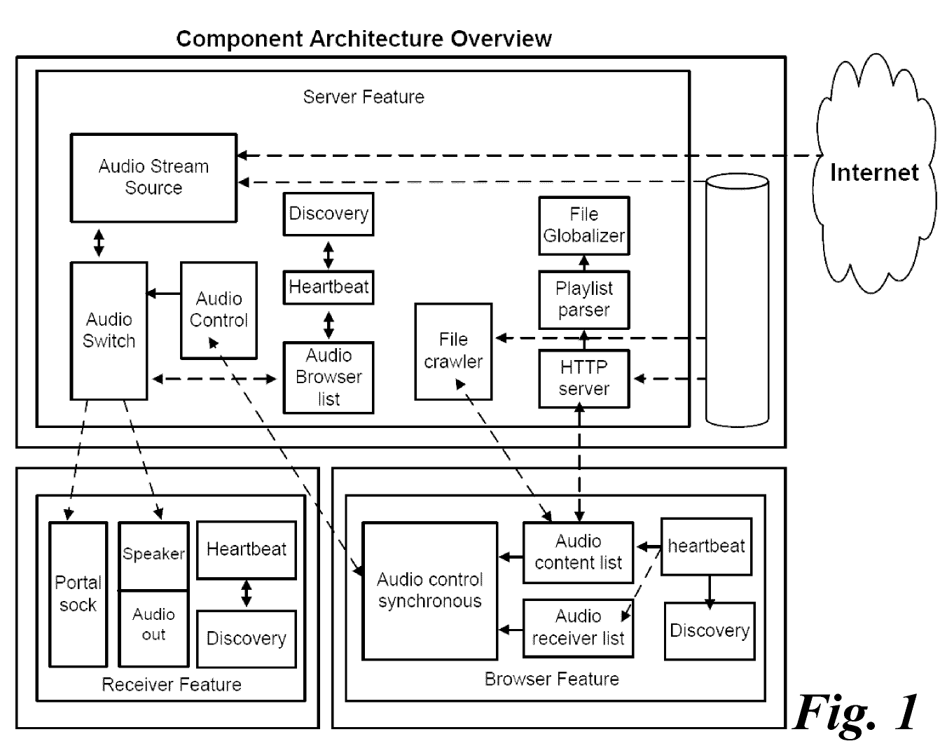

Process Summary. The diagram of FIG. 1 below details the high level overview of all of the components of the Vulcan architecture and the links between those components.

FIG. 1. illustrates an audio streaming component architecture overview that allows audio streaming to occur via an interface between each component. Operations and functioning of the component architecture diagram is detailed in the Component Interfaces Design document which is available at: Component Interfaces.xls.

The basic responsibility of each component in the FIG. 1 diagram above is as follows: The components include an audiostreamsource, an audioswitch, and audio control, an audiocontrolsynchronous, an audiobrowserlist, an audiocontentlist, an audioreceiverlist, an HTTPserver, a filecrawler, a playlist parcer, a fileglobalizer, and a heartbeat.

AudioStreamSource: Interface bead which receives commands from AudioSwitch and talks to audio source interface libraries such as Real Audio and Windows Media. Sends asynchronous events to AudioSwitch.

AudioSwitch: Receives commands from AudioControl and sends commands to AudioStreamSource. Receives events from AudioStreamSource and sends events to AudioBrowserList. Controls the switching of audio from AudioStreamSource to one or more Receivers. Requests playlist content (see: Playlist Parsers), upon receipt of a CreateActivity command that contains a Playlist or a SetPlaylist command. Receive commands on it's config edge to list all current activities that it owns.

AudioControl: Receives commands from AudioControlSynchronous and sends commands to AudioSwitch. Requests playlist content (see: Playlist Parsers), upon receipt of the ExpandPlaylist command from an Audio Browser.

AudioControlSynchronous: Receives events from AudioBrowserList, AudioContentList and AudioReceiverList. Sends commands to AudioControl on the server local to the requested content or on the server responsible for serving up internet content, when applicable. Generates unique ActvityIDs across all Audio Browsers, using IP address and sequential ID.

AudioBrowserList: Receives messages from Heartbeat about the addition/removal of Audio Browsers and requests the initial list of active activities from AudioSwitch when a new Audio Browser is detected. Receives events from AudioSwitch and sends events to all active Audio Browsers.

AudioContentList: Receives messages from Heartbeat about the addition/removal of Audio Servers. Users IP address of new server to get virtual roots from HTTPServer, and uses virtual roots to get audio content from FileCrawler. Forwards new (and removed) content events to AudioControlSynchronous.

AudioReceiverList: Receives messages from Heartbeat about the addition/removal of Audio Receivers and forwards those messages in the form of events to AudioControlSynchronous.

HTTPServer: Receive commands on it's config edge to add/remove/modify virtual roots. Receive a command on it's config edge to return contents of virtual roots table.

FileCrawler: Receive a command on it's config edge to return a list of files for a given HTTP virtual root (and it's subdirectories) for a given content type (i.e. extension). Transform all local files names into encoded URLs.

Playlist Parser Receive a format specific playlist and convert it into a generic filelist. There will actually be one PlaylistParser for each support playlist type, (i.e. M3UParse, PLSParse, ASXParse, etc.).

FileGlobalizer: Transforms local file names into URLs. It will be used in conjunction with the Playlist Parsers to return file lists with URLs instead of just local file names.

Heartbeat: On startup, post a message to discovery. announcing the presence, or absence, of each Strings feature, i.e., Local-Content Server, Internet Content Server, Receiver or Browser. Receive messages from discovery channels for each feature and forward events for each existing feature.

Design Concepts of the architecture is made up features which can be distributed in any way across hosts in the network. The only requirement is that at most one instance of a given feature can be running on a host at a time. The features that make up the architecture are the Server, Receiver and Browser. Server features can be further broken down to support local content, internet content or both. Heartbeat is responsible for discovering all features and forwarding corresponding events appropriately. AudioBrowserList will receive events for Browser features, AudioContentList will receive events for Server features and AudioReceiverList will receive events for Receiver features. All features can communicate asynchronously over a well known port using sockets, or synchronously via an HTTP request.

AudioControlSynchronous will receive all accessible content and receivers (from AudioContentList and AudioReceiverList, respectively) and all current activities from AudioBrowserList on startup. Subsequent events to AudioControlSynchronous will only contain deltas to the original data dump and will be initiated as follows: An event is sent from AudioBrowserList indicating a modification of an existing activity. An event is sent from AudioContentList indicating that a new PC came on-line with new playlist/audiofile info or an existing PC went off-line, thus removing existing playlist/audiofile info. An event is sent from AudioReceiverList indicating that a new audio receiver came on-line or an existing audio receiver went off-line.

When AudioContentList receives the event from Heartbeat announcing a new Server feature, it will request the virtual roots on that server from HTTPServer. Then, it will request the audio content for each virtual root, for each supported content type, from the FileCrawler on the newly discovered server. FileCrawler will be responsible for parsing each filename and replacing all local file prefixes with URLs. For example, if it finds a playlist with the URL: C:\My Documents\My Music\workout.m3u, it will need to change that to http:\\a.b.c.d\c\my documents\my music\workout.m3u, assuming the virtual root is set up such that c:\maps to http:\\a.b.c.d\c. FileCrawler will get the virtual roots from the HTTPServer config edge.

AudioContentList will also be responsible for sending an event to AudioControlSynchronous which details which servers are serving local content and which are serving internet content. This will allow AudioControlSynchronous to request audio content from the correct server.

When AudioSwitch receives a request from AudioControl to open a playlist, it will request the contents of the playlist, which will invoke a content specific playlist bead (i.e. M3UParse, PLSParse, ASXParse, etc.), to parse the results returned from HTTPClient and pass on the content independent results. The results from the playlist parser will be passed through FileGlobalizer to replace all local file names with encoded URLs.

XML Format Specification. The current assumption is that the structure of all commands and event interfaces will use an XML message format. However, all implementation should be done in a modular way such that this decision can be changed at a later date without major effect on the code.

Element List. This section documents all XML elements supported in the system is shown in Table 1 below. Each element is shown with it's associated attributes and all optional attributes will be in italics. If all attributes of a particular element are optional, it must contain at least one attribute to be valid. Child elements of a given element are not shown.

TABLE 1

| | |
|---|---|
| <CONTENT_EVENT | version=” 1.0” / > |
| <SERVER_EVENT | version=” 1.0” / > |
| <RECEIVER_EVENT | version=” 1.0” / > |
| <ACTIVITY_EVENT | version=” 1.0” / > |
| <PLAYBACK_EVENT | version=” 1.0” / > |
| <HEARTBEAT_EVENT | version=” 1.0” / > |
| <ACTIVITY_COMMAND | version=” 1.0” / > |
| <PLAYBACK_COMMAND | version=” 1.0” / > |
| <RESCAN_RESPONSE | version=” 1.0” / > |
| <HEARTBEAT_MESSAGE | version=” 1.0” / > |
| <FILE_EXTENSIONS | version=” 1.0” / > |
| <LIST_EXTENSIONS | version=” 1.0” / > |
| <HOSTS | version=” 1.0” / > |
| <VIRTUAL_ROOTS | version=” 1.0” / > |
| <MULTICAST_GROUPS | version=” 1.0” / > |

<ADD_TRACKS/>
<REMOVE_TRACKS/>
<ADD_PLAYLISTS/>
<REMOVE_PLAYLISTS/>
<ADD_INTERNET_SERVERS/>
<REMOVE_INTERNET_SERVERS/>
<ADD_LOCAL_SERVERS/>
<REMOVE_LOCAL_SERVERS/>
<ADD_RECEIVERS/>
<REMOVE_RECEIVERS/>
<ADD_TARGETS/>
<REMOVE_TARGETS/>
<ADD_HOST/>
<REMOVE_HOST/>
<CREATE_ACTIVITY/>
<SET_PLAYLIST/>
<SET_MODE/>
<RESET_CONTENT/>

| | |
|---|---|
| <VIRTUAL_ROOT | name=“ virtualRootName” |
| | localRoot=“localRootName”/> |
| <HOST | ipAddress=“ ipAddress” |
| | name=“ hostName” |
| | dnsName=“ dnsName” /> |
| <FILE | url=“linkName” fullName=“localName”/> |
| <IP_ADDRESS | value=“224 . 0. 0.xx” /> |
| <MODE | value=“Liner \| Random” /> |
| <STATUS | value=“Success \| Failure” /> |
| <ERROR/> | |
| <STRINGS_CODE | value=“errorValue” /> |
| <ACTIVITY | id=“ id” name=“ name” /> |
| <STATE | value = |
| | “Idle \| Connecting \| Buffering \| Playing \| Paused \| |
| | Stopped \| Closed \| Error” /> |
| <FILELIST /> | |
| <PLAYLIST /> | |
| <TRACK /> | |
| <EXTENSION /> | value“ extension” /> |
| <PROGRESS | value=“ 100” units=“percentage” /> |
| <LENGTH | value=“ 0” units=“milliseconds” /> |
| <POSITION | value=“ 0” units=“milliseconds” /> |
| <TITLE | name=“Title” /> |
| <ARTIST | name=“Artist” /> |
| <ALBUM | name=“Album” /> |
| <GENRE | name=“ Genre” /> |
| <OPEN/> | |
| <PLAY/> | |
| STOP/> | |
| NEXT/> | |
| PREVIOUS/> | |
| SEEK/> | offset==“ value” units=“milliseconds” /> |
| PAUSE/> | |
| RESUME/> | |
| CLOSE/> | |

Element Structure is shown in table 2 below. This section documents the structure of the supported XML elements, by outlining the parent-child relationships between all of the elements. Attributes of each element are not included in this section.

TABLE 2

| Element | Valid Parent Elements | Valid Child Elements |
|---|---|---|
| ACTIVITY | ACTIVITY_COMMAND, | ADD_TARGETS, ADD_TRACKS, |
| | ACTIVITY_EVENT | ALBUM, ARTIST, CLOSE, |
| | | CREATE_ACTIVITY, ERROR, |
| | | GENRE, LENGTH, NEXT, |
| | | PAUSE, PLAY, PLAYLIST, |
| | | POSITION, PREVIOUS, PROGRESS, |
| | | REMOVE_TARGETS, |
| | | REMOVE_TRACKS, |
| | | RESET_CONTENT, RESUME, |
| | | SET_MODE, SET_PLAYLIST, SEEK, |
| | | STATE, STOP, TITLE, TRACK |
| ACTIVITY_COMMAND | NONE | ACTIVITY |
| ACTIVITY_EVENT | NONE | ACTIVITY, ERROR |
| ADD_HOST | HEARTBEAT_EVENT | HOST |
| ADD_INTERNET_SERVERS | SERVER_EVENT | HOST |
| ADD_LOCAL_SERVERS | SERVER_EVENT | HOST |
| ADD_PLAYLISTS | CONTENT_EVENT | FILE |
| ADD_RECEIVERS | RECEIVER_EVENT | HOST |
| ADD_TARGETS | ACTIVITY, | HOST |
| | CREATE_ACTIVITY | |
| ADD_TRACKS | ACTIVITY, | FILE |
| | CONTENT_EVENT, | |
| | CREATE_ACTIVITY | |
| ALBUM | ACTIVITY, | NONE |
| | PLAYBACK_EVENT | |
| ARTIST | ACTIVITY, | NONE |
| | PLAYBACK_EVENT | |
| CLOSE | ACTIVITY | NONE |
| CONTENT_EVENT | NONE | ADD_PLAYLISTS, |
| | | ADD_TRACKS,_ERROR, |
| | | REMOVE_PLAYLISTS, |
| | | REMOVE_TRACKS |
| CREATE_ACTIVITY | ACTIVITY | ADD_TARGETS,_ADD_TRACKS, |
| | | SET_MODE,_SET_PLAYLIST |
| ERROR | ACTIVITY, | STRINGS_CODE |
| | ACTIVITY_EVENT, | |
| | CONTENT_EVENT, | |
| | PLAYBACK_EVENT, | |
| | RECEIVER_EVENT | |
| EXTENSION | FILE_EXTESIONS, | NONE |
| | LIST_EXTENSIONS | |
| FEATURE_AVAILABLE | HEARTBEAT_MESSAGE | NONE |
| FEATURE_NOT_AVAILABLE | HEARTBEAT_MESSAGE | NONE |
| FILE | ADD_PLAYLISTS, | NONE |
| | ADD_TRACKS, FILELIST, | |
| | OPEN, PLAYLIST, | |
| | REMOVE_PLAYLISTS, | |
| | REMOVE_TRACKS, | |
| | SET_PLAYLIST, TRACK | |
| FILE_EXTENSIONS | NONE | EXTENSION |
| FILELIST | NONE | FILE |
| GENRE | ACTIVITY, | NONE |
| | PLAYBACK_EVENT | |
| HEARTBEAT_EVENT | NONE | ADD_HOST, REMOVE_HOST |
| HEARTBEAT_MESSAGE | NONE | FEATURE_AVAILABLE, |
| | | FEATURE_NOT_AVAILABLE |
| HOSTS | NONE | HOST |
| HOST | ADD_HOST, | NONE |
| | ADD_RECEIVERS, | |
| | ADD_TARGETS, | |
| | HEARTBEAT, HOSTS, | |
| | REMOVE_HOST, | |
| | REMOVE_RECEIVER, | |
| | REMOVE_TARGETS | |
| IP_ADDRESS | MULTI_CAST_GROUP S | NONE |
| LENGTH | ACTIVITY, | NONE |
| | PLAYBACK_EVENT | |
| LIST_EXTENSIONS | NONE | EXTENSION |
| MODE | SET_MODE | NONE |
| MULTICAST_GROUPS | NONE | IP_ADDRESS |
| NEXT | ACTIVITY | NONE |
| OPEN | PLAYBACK_COMMAND | FILE |
| PAUSE | ACTIVITY, | NONE |
| | PLAYBACK_COMMAND | |
| PLAY | ACTIVITY, | NONE |
| | PLAYBACK_COMMAND | |
| PLAYBACK_COMMAND | NONE | OPEN, PAUSE, PLAY, RESUME, |
| | | SEEK, STOP |
| PLAYBACK_EVENT | NONE | ALBUM, ARTIST, ERROR, |
| | | GENRE, LENGTH, POSITION, |
| | | PROGRESS, STATE, TITLE |
| PLAYLIST | ACTIVITY | FILE |
| POSITION | ACTIVITY, | NONE |
| | PLAYBACK_EVENT | |
| PREVIOUS | ACTIVITY | NONE |
| PROGRESS | ACTIVITY, | NONE |
| | PLAYBACK_COMMAND | |
| RECEIVER_EVENT | NONE | ADD_RECEIVERS, ERROR, |
| | | REMOVE_RECEIVERS |
| REMOVE_HOST | HEARTBEAT_EVENT | HOST |
| REMOVE_INTERNET_SERVERS | SERVER_RESPONSE | HOST |
| REMOVE_LOCAL_SERVERS | SERVER_RESPONSE | HOST |
| REMOVE_PLAYLISTS | CONTENT_EVENT | FILE |
| REMOVE_RECEIVERS | RECEIVER_EVENT | HOST |
| REMOVE_TARGETS | ACTIVITY | HOST |
| REMOVE_TRACKS | ACTIVITY, | FILE |
| | CONTENT_EVENT | |
| RESCAN_RESPONSE | NONE | STATUS |
| RESET_CONTENT | ACTIVITY | NONE |
| RESUME | ACTIVITY, | NONE |
| | PLAYBACK_COMMAND | |
| SEEK | ACTIVITY, | NONE |
| | PLAYBACK_COMMAND | |
| SERVER_RESPONSE | NONE | ADD_INTERNET_SERVERS, |
| | | ADD_LOCAL_SERVERS, |
| | | REMOVE_INTERNET_SERVERS, |
| | | REMOVE_LOCAL_SERVERS |
| SET_MODE | ACTIVITY, | MODE |
| | CREATE_ACTIVITY | |
| SET_PLAYLIST | ACTIVITY, | FILE |
| | CREATE_ACTIVITY | |
| STATE | ACTIVITY, | NONE |
| | PLAYBACK_EVENT | |
| STATUS | RESCAN_RESPONSE | NONE |
| STOP | ACTIVITY, | NONE |
| | PLAYBACK_COMMAND | |
| STRINGS_CODE | ERROR | NONE |
| TITLE | ACTIVITY, | NONE |
| | PLAYBACK_EVENT | |
| TRACK | ACTIVITY | FILE |
| VIRTUAL_ROOT | VIRTUAL_ROOTS | NONE |
| VIRTUAL_ROOTS | NONE | VIRTUAL_ROOT |

Protocol Interface Specification. This section describes all protocol interfaces which utilize XML and query string message format. This includes all command, event and config edges as well as interfaces to discovery and initialization file formats.

AudioControlSynchronous. AudioControlSynchronous supports an Event Interface on which it receives events from AudioBrowserList, AudioContentList and AudioReceiverList to drive the GUI and a config interface on which it receives commands from a web browser, however, the config interface is not included in this document. It also outputs commands to the AudioControl Command Interface and Config Interface.

Event Interface This interface supports four separate events: content, server, receiver and activity events. Event event is described in detail below. The first type of event is a content event which contains changes to the available content based on the availability of server features on the network. AudioControlSynchronous can support any combination of elements under the CONTENT_EVENT root element. AudioControlSynchronous will also need to be robust enough to support duplicate add and remove events, by ignoring all but the first event. The structure of a content event is as follows in Table 3 below:

```
TABLE 3
    <?xml version=“1.0” encoding=“UTF-8” standalone=“yes” ?>
<CONTENT_EVENT version=“ 1.0”>
    <ERROR>
```

| | |
|---|---|
| <STRINGS_CODE | value=“ errorValue” /> |
| </ ERROR> | |
| <ADD_TRACKS> | |
| <FILE url=“ linkName” | fullName=“ localName” /> |
| <FILE url=“ linkName” | fullName=“ localName” /> |
| </ ADD_TRACKS> | |
| <ADD_PLAYLISTS> | |
| <FILE url=“ linkName” | fullName=“ localName” /> |
| <FILE url=“ linkName” | fullName=“ localName” /> |
| </ ADD_PLAYLISTS> | |
| <REMOVE_TRACKS> | |
| <FILE url=“ linkName” | fullName=“ localName” /> |
| <FILE url=“ linkName” | fullName=“ localName” /> |
| </ REMOVE_TRACKS> | |
| <REMOVE_PLAYLISTS> | |
| <FILE url=“ linkName” | fullName=“ localName” /> |
| <FILE url=“ linkName” | fullName=“ localName” /> |
| </ REMOVE_PLAYLISTS> | |
| </CONTENT_EVENT> | |

The second type of event is a server event which contains changes to the available servers based on the availability of server features on the network, and whether a server supports local content, internet content or both. AudioControlSynchronous can support any combination of elements under the SERVER_EVENT root element. AudioControlSynchronous will also need to be robust enough to support duplicate add and remove events, by ignoring all but the first event. The structure of a server event is shown in Table 4 as follows:

TABLE 4

| <?xml version=“1.0” encoding=“UTF-8” standalone=“yes” ?> | |
|---|---|
| <SERVER_EVENT version=“ 1.0” > | |
| <ERROR> | |
| <STRINGS_CODE value=“ errorValue” /> | |
| </ ERROR> | |
| </ADD_INTERNET_SERVERS> | |
| <HOST | ipAddress=“ ipAddress” |
| | name=“ hostName” |
| | dnsName=“ dnsName” /> |
| </ADD_INTERNET_SERVERS> | |
| <ADD_LOCAL_SERVERS> | |
| <HOST | ipAddress=“ ipAddress” |
| | name=“ hostName” |
| | dnsName=“ dnsName” /> |
| </ ADD_LOCAL_SERVERS> | |
| <REMOVE_INTERNET_SERVERS> | |
| <HOST | ipAddress=“ ipAddress” |
| | name=“ hostName” |
| | dnsName=“ dnsName” /> |
| </ REMOVE_INTERNET_SERVERS> | |
| <REMOVE_LOCAL_SERVERS> | |
| <HOST | ipAddress=“ ipAddress” |
| | name=“ hostName” |
| | dnsName=“ dnsName” /> |

</ REMOVE_LOCAL_SERVERS>
</ SERVER_EVENT>

The third type of event is a receiver event which contains changes to the available receivers based on the availability of receiver features on the network.

AudioControlSynchronous can support any combination of elements under the RECEIVER_EVENT root element. AudioControlSynchronous will also need to be robust enough to support duplicate add and remove events, by ignoring all but the first event. The structure of a receiver event is shown in Table 5 as follows:

TABLE 5

| <?xml version=“1.0” encoding=“UTF-8” standalone=“yes” ?> | |
|---|---|
| <RECEIVER_EVENT version=“ 1.0” > | |
| <ERROR> | |
| <STRINGS_CODE value=“ errorValue” /> | |
| </ERROR> | |
| </ADD_RECEIVERS> | |
| <HOST | ipAddress=“ ipAddress” |
| | name=“ hostName” |
| | dnsName=“ dnsName” /> |
| </ ADD_RECEIVERS> | |
| <REMOVE_RECEIVERS> | |
| <HOST | ipAddress=“ ipAddress” |
| | name=“ hostName” |
| | dnsName=“ dnsName” /> |

```
    </ REMOVE_RECEIVERS>
    </ RECEIVER_EVENT>
```

The fourth type of event is an activity event which contains changes to the active activities in the system. An activity event can contain multiple ACTIVITY elements and an ACTIVITY element can contain any combination of child elements. The structure of an activity event is shown in Table 6 as follows:

TABLE 6

| <ACTIVITY_EVENT version=“ 1.0” > | |
|---|---|
| <ERROR> | |
| <STRINGS_CODE value=“ errorValue” /> | |
| </ERROR> | |
| <ACTIVITY id=“ id” name=“name” > | |
| <ERROR> | |
| <STRINGS_CODE value=“ errorValue” /> | |
| </ERROR> | |
| <ADD_TARGETS> | |
| <HOST | ipAddress=“ ipAddress” |
| | name=“ hostName” |
| | dnsName=“ dnsName” /> |
| <ADD_TARGETS> | |
| <REMOVE_TARGETS | |
| <HOST | ipAddress=“ ipAddress” |
| | name=“ hostName” |
| | dnsName=“ dnsName” /> |
| <REMOVE_TARGETS | |
| <PLAYLIST> | |
| <FILE url=“ linkName” fullName=“ localName” /> | |
| </ PLAYLIST> | |
| <TRACK> | |
| <FILE url=“ linkName” fullName=“ localName” /> | |
| </ TRACK> | |
| <STATE | value = |
| | “Idle \| Connecting \| Buffering \| Playing \| Paused \| |
| | Stopped \| Closed \| Error” /> |
| <PROGRESS | value=“ 100” units=“percentage” /> |
| <LENGTH | value=“ 0” units=“milliseconds” /> |
| <POSITION | value=“ 0” units=“milliseconds” /> |
| <TITLE | name=“Title” /> |
| <ARTIST | name=“Artist” /> |
| <ALBUM | name=“Album” /> |
| <GENRE | name=“Genre” /> |

```
    <CLOSE/>
    </ACTIVITY>
</ACTIVITY_EVENT>
```

Note that AudioControlSynchronous will also receive content events, server events, receiver events and activity events on startup to set the initial state of the system.

AudioControl_AudioControl supports a Command Interface on which it receives commands from AudioControlSynchronous and a Config Interface that supports synchronous requests from AudioControlSynchronous. It also outputs commands to the AudioSwitch Command Interface.

Command Interface. The AudioControl command interface supports activity commands. Activity commands act on a specific activity and can contain at most one ACTIVITY element, but an ACTIVITY element can contain any combination of child elements. All activity commands require an ActivityId. The ActivityId is generated by AudioControlSynchronous and will be a combination of the IP address where the browser feature is running and a unique sequentional identifier. i.e. 10.1.1.20.1, 10.1.1.20.2, etc. Once the unique ActivityId is generated, AudioControlSynchronous can send multiple commands per activity as required. The complete structure is shown in Table 7 as follows:

```
TABLE 7
  <?xml  version=“1.0” encoding=“UTF-8”  standalone=“yes” ?>
<ACTIVITY_COMMAND version=“ 1.0” >
<ACTIVITY id=“id” name=“name”>
    <CREATE_ACTIVITY>
        <ADD_TARGETS>
```

| | |
|---|---|
| <HOST | ipAddress=“ ipAddress” |
| | name=“ hostName” |
| | dnsName=“ dnsName” /> |
| <HOST | ipAddress=“ ipAddress” |
| | name=“ hostName” |
| | dnsName=“ dnsName” /> |

```
        <ADD_TARGETS>
        <SET_PLAYLIST>
        <FILE  url=“ linkName”  fullName=“ localName” />
        <SET_PLAYLIST>
        <ADD_TRACKS>
        <FILE  url=“ linkName”  fullName=“ localName” />
        <FILE  url=“ linkName”  fullName=“ localName” />
        <FILE  url=“ linkName”  fullName=“ localName” />
        </ADD_TRACKS>
        <SET_MODE>
            <MODE  value=“ Linear 1 Random” />
        </ SET_MODE>
  </ CREATE_ACTIVITY>
  <PLAY/>
  <ADD_TRACKS>
    <FILE  url=“ linkName”  fullName=“ localName” />
    <FILE  url=“ linkName”  fullName=“ localName” />
  </ ADD_TRACKS>
  <REMOVE_TRACKS>
    <FILE  url=“ linkName”  fullName=“ localName” />
    <FILE  url=“ linkName”  fullName=“ localName” />
  </ REMOVE_TRACKS>
  <SET_PLAYLIST>
    <FILE  url=“ linkName”  fullName=“ localName” />
  </ SET_PLAYLIST>
  <SET_MODE  value=“Linear | Random” />
  <RESET_CONTENT/>
  <STOP/>
  <NEXT/>
  <PREVIOUS
  <SEEK  offset=“  value”  units=“ milliseconds” />
  <PAUSE/>
  <RESUME/>
  <ADD_TARGETS>
```

| | |
|---|---|
| <HOST | ipAddress=“ ipAddress” |
| | name=“ hostName” |
| | dnsName=“ dnsName” /> |

```
  </ADD_TARGETS>
  <REMOVE_TARGETS>
```

| | |
|---|---|
| <HOST | ipAddress=“ ipAddress” |
| | name=“ hostName” |
| | dnsName=“ dnsName” /> |

```
  </REMOVE_TARGETS>
  <CLOSE/>
</ACTIVITY>
        </ACTIVITY_COMMAND>
```

The CREATE ACTIVITY command described above has very specific semantics as follows:

| # of | # of | | |
|---|---|---|---|
| Playlists | Tracks | Mode | Description |
| 0 | 0 | Ignored | INVALID |
| 0 | 1 | Ignored | Play single track only. |
| 1 | 1 | Linear* | Play list starting at selected |
| | | | track. |
| 1 | 0 | Linear* | Play list starting at first track, |
| | | | continue sequentially until end. |
| 1 | 0 | Random | Play list starting at random |
| | | | track, continue randomly until all songs |
| | | | played. |
| 0 | 2+ | Linear* | Play all tracks in order received. |
| 0 | 2+ | Random | Play all tracks in random order. |
| 1 | 2+ | Ignored | INVALID |

*Default

Config Interface. There is one command supported by the AudioControl config interface, called ExpandPlaylist and the syntax is as follows:

http://ipAddress/portal/protocols/AudioControl?Command=ExpandPlaylist&Url=playlistUrl

ExpandPlaylist returns the contents of the requested playlist with all local file names translated into encoded URLs. The structure of the return message is shown in Table 8 as follows:

TABLE 8

<?xml version=“1.0” encoding=“UTF-8” standalone=“yes” ?>
<FILELIST version=“ 1.0” >
<FILE url=“ linkName” fullName=“ localName” />
<FILE url=“ linkName” fullName=“ localName” />
<FILE url=“ linkName” fullName=“ localName” />
<FILE url=“ linkName” fullName=“ localName” />
</FILELIST>

AudioSwitch. AudioSwitch supports a Command Interface on which it receives commands from AudioControl, an Event Interface on which it receives events from AudioStreamSource and a Config Interface on which it receives synchronous command requests from AudioBrowserList. It also outputs commands to the AudioStreamSource Command Interface and activity events to the AudioBrowserList Event Interface.

Command Interface. AudioSwitch supports the same command interface as AudioControl, since AudioControl is just responsible for sending commands to the correct session of AudioSwitch. For the complete interface specification, see AudioControl Command Interface.

Event Interface. The data sent to AudioSwitch from AudioStreamSource via the AudioSwitch event interface captures changes in the current status of the AudioStreamSource session. AudioStreamSource will be sending events and audio data to AudioSwitch via the event edge, so all payload data, include the XML event messages will have an RTP header on them to differentiate the audio from the events. AudioSwitch can support any combination of elements under the PLAYBACK-EVENT root element. The complete interface is shown in Table 9 as follows:

TABLE 9

| <?xml version=“1.0” encoding=“UTF-8” standalone=“yes” ?> | |
|---|---|
| <PLAYBACK_EVENT version=“ 1.0” > | |
| <ERROR> | |
| <STRINGS_CODE value=“ errorValue” /> | |
| </ERROR> | |
| <STATE | value = \| Buffering \| Playing \| Paused \| Stopped \| |
| | Closed \| Error” /> |

| | |
|---|---|
| <PROGRESS | value=“ 100” units=“percentage” /> |
| <LENGTH | value=“ 0” units=“milliseconds” /> |
| <TITLE | name=“Title” /> |
| <ARTIST | name=“Artist” /> |
| <ALBUM | name=“Album” /> |
| <GENRE | name=“ Genre” /> |

</ PLAYBACK _EVENT>

Config Interface. There is one command supported by the AudioSwitch config interface, called ListActivities, which returns all of the currently active activities owned by AudioSwitch, and the syntax is as follows:

http://ipAddress/portal/protocols/AudioSwitch?Command=ListActivities

The structure of the return message is the same as the activity event as defined by the AudioBrowserList Event Interface.

AudioStreamSource

AudioStreamSource supports a Command Interface on which it receives commands from AudioSwitch. It also outputs events to the AudioSwitch Event Interface.

Command Interface. AudioStreamSource receives commands from AudioSwitch which manage the AudioStreamSource session and the audio being streamed by that session. AudioStreamSource can support any combination of elements under the PLAYBACK_COMMAND root element. The complete structure is shown in Table 10 as follows.

TABLE 10

<?xml version=“1.0” encoding=“UTF-8” standalone=“yes” ?>
<PLAYBACK_COMMAND version=“ 1.0” >
<OPEN>
<FILE url=“ linkName” fullName=“ localName” />
</OPEN>
<PLAY/>
<STOP/>
<SEEK offset=“ value” units=“ milliseconds” />
<PAUSE/>
<RESUME/> </ PLAYBACK_COMMAND>

Config Interface. There is one command supported by the AudioStreamSource config interface, called ListMetadata, which returns all available information about a URL, and the syntax is as follows:

http://ipAddress/portal/protocols/AudioStreamSource?Command=ListMeta data&Url=url

The structure of the return message is the same as the PLAYBACK EVENT as defined by the AudioSwitch Event Interface.

FileCrawler. FileCrawler supports a Config Interface on which it receives synchronous commands from AudioContentList.

Config Interface. There is one command supported by the FileCrawler config interface, called ListFiles, which returns all of the files under the virtual root directory that match the given extension.

http://ipAddress/portal/protocols/FileCrawler?Command=ListFiles&Root=virtualRoot&Extension=extension

The structure of the return message is shown in Table 11 as follows:

TABLE 11

```
  <?xml version=“1.0” encoding=“UTF-8” standalone=“yes” ?>.
<FILELIST version=“ 1.0” >
    <FILE  url=“ linkName”  fullName=“ localName” />
    <FILE  url=“ linkName”  fullName=“ localName” />
    <FILE  url=“ linkName”  fullName=“ localName” />
</ FILELIST>
```

AudioBrowserList. AudioBrowserList supports an Event Interface on which it receives events from AudioSwitch with current activity information and it outputs activity events as specified by the AudioControlSynchronousEvent Interface. It also supports a Heartbeat Interface on which it receives events from Heartbeat announcing the addition or removal of new browser features to and from the network.

Event Interface_AudioBrowserList supports the same event interface as AudioControlSynchronous since AudioBrowserList is just responsible for multiplexing the events it receives to all connected browser features. For the complete interface specification, see AudioControlSynchronous Event Interface.

Heartbeat Interface. This interface receives a heartbeat event from Heartbeat announcing the addition or removal of a host which is currently running the browser feature. The structure of a heartbeat event is shown in Table 12 as follows:

TABLE 12

| <HEARTBEAT_EVENT version=“ 1 . 0”> | |
|---|---|
| <ADD_HOST> | |
| <HOST | ipAddress=“ ipAddress” |
| | name=“ hostName” |
| | dnsName=“ dnsName” /> |
| </ADD_HOST> | |
| <REMOVE_HOST> | |
| <HOST | ipAddress=“ ipAddress” |
| | name=“ hostName” |
| | dnsName=“ dnsName” /> |

</ REMOVE_HOST>
</ HEARTBEAT_EVENT>

AudioContentList supports a Config Interface on which it receives synchronous commands and it outputs content events and server events as specified by the AudioControlSynchronous Event Interface. It also supports a Heartbeat Interface on which it receives events from Heartbeat announcing the addition or removal of new server features to and from the network. Lastly, it requires an initialization file to define the supported file and playlist types.

Config Interface. At a high level the AudioContentList config interface needs to support the ability to list all of the content currently accessible across the network. In addition, it needs to provide an interface to allow the user to rescan content that may have changed. This can be done globally, for a particular host or for a particular virtual root on a host.

The first command supported by the config interface is called ListContent, which returns all of the content currently available across all discovered server features.

http://ipAddress/portal/protocols/AudioContentList?Command=ListContent

The structure of the return message is shown in Table 13 as follows:

TABLE 13

```
<?xml version=“1.0” encoding=“UTF-8”  standalone=“yes” ?>
<CONTENT_EVENT version=“1.0”>
<ADD_TRACKS>
    <FILE  url=“ linkName”  fullName=“ localName” />
    <FILE  url=“ linkName”  fullName=“ localName” />
</ ADD_TRACKS>
<ADD_PLAYLISTS>
    <FILE  url=“ linkName”  fullName=“ localName” />
    <FILE  url=“ linkName”  fullName=“ localName” />
</ ADD_PLAYLISTS>
</ CONTENT_EVENT>
```

The commands supported to rescan content are as follows:

http://ipAddress/portal/protocols/AudioContentList?Command=ListHosts

http://ipAddress/portal/protocols/AudioContentList?Command=ListVirtualRoots&Host=ipAddress

http://ipAddress/portal/protocols/AudioContentList?Command=Rescan

http://ipAddress/portal/protocols/AudioContentList?Command=Rescan&Host=ipAddress

http://ipAddress/portal/protocols/AudioContentList?Command=Rescan&Host=ipAddress&VirtualRoot=virtualRoot

The first command will return all hosts currently accessible in the system. The structure of the return message is shown in Table 14 as follows:

TABLE 14

| <?xml version=“1.0” encoding=“UTF-8” standalone=“yes” ?> | |
|---|---|
| <HOSTS version=“ 1. 0” > | |
| <HOST | ipAddress=“ ipAddress” |
| | name=“ hostName” |
| | dnsName=“ dnsName” /> |
| <HOST | ipAddress=“ ipAddress” |
| | name=“ hostName” |
| | dnsName=“ dnsName” /> |
| | </ HOSTS> |

The second command will return all virtual roots for a given host. The structure of the return message is shown in Table 15 as follows:

TABLE 15

| <?xml version=“1.0” encoding=“UTF-8” standalone=“yes” ?> | |
|---|---|
| <VIRTUAL_ROOTS version=“ 1.0”> | |
| <VIRTUAL_ROOT | name=“ virtualRootName” |
| | localRoot=“ localRootName” /> |
| <VIRTUAL_ROOT | name=“ virtualRootName” |
| | localRoot=“ localRootName” /> |
| <VIRTUAL_ROOT | name=“ virtualRootName” |
| | localRoot=“ localRootName” /> |
| </VIRTUAL_ROOTS> | |

The remaining three commands will scan all hosts, a particular host or a particular virtual root, respectively and will result in a CONTENT EVENT being sent as defined by the AudioControlSynchronous Event Interface. The config edge will return a status message shown in Table 16 as follows:

TABLE 16
<?xml version=“1.0” encoding=“UTF-8” standalone=“yes” ?>
<RESCAN_RESONSE version=“ 1.0” >

<STATUS value=“ Success | Failure” />

</RESCAN_RESPONSE>

Heartbeat Interface. This interface receives a heartbeat event from Heartbeat announcing the addition or removal of a host which is currently running the server feature. The structure of a HEARTBEAT EVENT is the same as defined by the AudioBrowserList Heartbeat Interface.

Initialization File. The AudioContentList.protocol initialization file, will contain data in XML format which describes what the supported audio content types are and which types are lists and which are single files. The XML format and will look like the following shown in Table 17 below:

TABLE 17

```
<?xml version=‘1.0’ encoding=‘UTF-8’  standalone=‘yes’ ?>
<PROTOCOL name=‘AudioContentList’>
<INITFILE module=‘AudioContentList’>
<FILE_EXTENSIONS version=“1.0”>
    <EXTENSION  value=“ mp3” />
    <EXTENSION  value=“ wav” />
    <EXTENSION  value=“ wma” />
</FILE_EXTENSIONS>
<LIST_EXTENSIONS version=“1.0”>
    <EXTENSION  value=“ m3u” />
    <EXTENSION  value=“ pls” />
    <EXTENSION  value=“ asx” />
</ LIST_EXTENSIONS>
</ INITFILE>
</ PROTOCOL>
```

Note that this is just an example and does not represent a complete list.

AudioReceiverList supports a Config Interface on which it receives synchronous commands and it outputs receiver events as specified by the AudioControlSynchronous Event Interface. It also supports a Heartbeat Interface on which it receives events from Heartbeat announcing the addition or removal of new receiver features to and from the network.

Config Interface. There is one command supported by the AudioReceiverList config interface, called ListReceivers, which returns all of the discovered receivers.

http://ipAddress/portal/protocols/AudioReceiverList?Command=ListReceivers

The structure of the return message is as follows as shown in Table 18 below:

TABLE 18

| <?xml version=“1.0” encoding=“UTF-8” standalone=“yes” ?> | |
|---|---|
| <RECEIVER_EVENT version=“1.0”> | |
| <ADD_RECEIVERS> | |
| <HOST | ipAddress=“ ipAddress” |
| | name=“ hostName” |
| | dnsName=“ dnsName” /> |
| <HOST | ipAddress=“ ipAddress” |
| | name=“ hostName” |
| | dnsName=“ dnsName” /> |
| <HOST | ipAddress=“ ipAddress” |
| | name=“ hostName” |
| | dnsName=“ dnsName” /> |

</ADD_RECEIVERS>
</RECEIVER_EVENT>

Heartbeat Interface. This interface receives a heartbeat event from Heartbeat announcing the addition or removal of a host which is currently running the receiver feature. The structure of a HEARTBEAT EVENT is the same as defined by the AudioBrowserList Heartbeat Interface.

HTTPServer. HTTPServer supports a Config Interface on which it receives synchronous commands from AudioContentList. It requires an initialization file to define the supported virtual roots.

Config Interface._At a high level the HTTPServer config interface needs to support the ability to list the contents of the current virtual roots as well as the ability to modify the current virtual roots. This will translate to a number of supported commands as follows as shown in Table 19 below. The structure of the return message is the same for all commands, as all commands will return the current contents of the virtual roots table after the command is executed. The structure is as follows:

```
TABLE 19
http: //ipAddress/portal/protocols/https?Command=ListVirtualRoots
    http://ipAddress/portal/protocols/https?Command=
    AddVirtualRoot&Name=virtualRoot&LocalRoot
    http://ipAddress/portal/protocols/https?Command=
    RemoveVirtualRoot&Name=virtualRoot&LocalRoot=localRoot
        <?xml version=“1.0” encoding=“UTF-8”  standalone=“yes” ?>
        <VIRTUAL_ROOTS version=“ 1.0”>
                            <VIRTUAL_ROOT name=“
    virtualRootName”
                                localRoot=“ localRootName”/>
                            <VIRTUAL_ROOT name=
                          “virtualRootName”
                                localRoot=“ localRootName”/>
                            <VIRTUAL_ROOT name=“
    virtualRootName”
                                localRoot=“ localRootName”/>
                    </ VIRTUAL_ROOTS>
```

Since the virtual roots are persistent, the AddVirtualRoot and RemoveVirtualRoot commands will need to modify the contents of the initialization file.

Initialization File. The HTTPServer.protocol initialization file, will contain the same XML format that is returned from the config edge and will look like the following as shown in Table 20 below:

TABLE 20
<?xml version=‘1.0’ encoding=‘UTF-8’ standalone=‘yes’ ?>
<PROTOCOL name=‘HTTPServer’>
<INITFILE module=‘HTTPServer’>
<VIRTUAL_ROOTS version=“ 1.0”>

| | |
|---|---|
| <VIRTUAL_ROOT | name=“ virtualRootName” |
| | localRoot=“ localRootName”/> |
| <VIRTUAL_ROOT | name=“ virtualRootName” |
| | localRoot=“ localRootName”/> |
| <VIRTUAL_ROOT | name=“ virtualRootName” |
| | localRoot=“ localRootName”/> |

</ VIRTUAL_ROOTS>
</ INITFILE>
</ PROTOCOL>

PortalSock. PortalSock supports a Config Interface on which it receives synchronous commands from AudioSwitch to add or remove the given host to or from a multicast group.

Config Interface. The PortalSock config interface needs to support the ability to add the host it is running on to a given multicast group, the ability to remove the host from the multicast group and to report which multicast groups the host is currently a part of This will translate to the following supported commands as shown in Table 21 below:

TABLE 21

http://ipAddress/portal/protocols/PortalSock?command=
JoinMulticastGroup&IpAddress=224.0.0.XX
http://ipAddress/portal/protocols/PortalSock?command=
LeaveMulticastGroup&IpAddress=224.0.0.XX
http://ipAddress/portal/protocols/PortalSock?command=
ListMulticastGroups

All three commands should return a current list of the multicast groups that the host is currently part of after the command completes, as follows as shown in Table 22 below:

```
TABLE 22
<?xml version=“1.0”encoding=“UTF-8” standalone=“yes” ?>
    <MULTICAST_GROUPS version=“1.0” >
        <IP_ADDRESS value=“ 224.0.0.xx” />
        <IP_ADDRESS value=“ 224.0.0.xx” />
    </MULTICAST_GROUPS>
```

Playlist Parsers. All Playlist Parsers (i.e. M3Uparse, ASXParse, PLSParse, etc.) will take in the contents of the content specific playlist file, via an HTTP request on their data edge, and output an XML message with the following format as shown in Table 23 below:

TABLE 23

```
<?xml  version=“1.0”encoding=“UTF-8” standalone=“yes” ?>
    <FILELIST version=“ 1.0” >
        <FILE fullName=“ localName” />
        <FILE fullName=“ localName” />
        <FILE fullName=“ localName” />
    </FILELIST>
```

Note that the Playlist Parsers are only responsible for filling in the local file names.

FileGlobalizer. The FileGlobalizer will take in XML data using the FILELIST element, as output by the Playlist Parsers and is responsible for adding the url attribute, by using the VIRTUAL_ROOTS available via HTTPServer's config edge. All urls added by FileGlobalizer should be encoded for correct transport. The output message of the FileGlobalizer data edge is as follows as shown in Table 24 below:

```
TABLE 24
<?xml  version=“1.0” encoding=“UTF-8” standalone=“yes” ?>
FILELIST version=“ 1.0” >
    <FILE url=“ linkName” fullName=“ localName” />
    <FILE url=“ linkName” fullName=“ localName” />
    <FILE url=“ linkName” fullName=“ localName” />
</ FILELIST>
```

Heartbeat. The Heartbeat protocol will run on all hosts and broadcast a message to discovery on startup announcing the availability of the host. The feature that the host is announcing, will be determined by the channel that the Heartbeat broadcasts over. The contents of the message will indicate whether the feature is available on the given host. Which features are available will be specified in the Heartbeat initialization file. The format of the message sent to discovery on startup is as follows as shown in Table 25 below:

TABLE 25

```
<?xml version=“1.0” encoding=“UTF-8” standalone=“yes” ?>
    <HEARTBEAT_MESSAGE version=“1.0” >
    <FEATURE_AVAILABLE/>
    <FEATURE_NOT_AVAILABLE/>
    </ HEARTBEAT_MESSAGE>
```

The message must contain either the FEATURE_AVAILABLE tag or the FEATURE_NOT_AVAILABLE tag, but not both.

The format of the Heartbeat initialization file is as follows as shown in Table 26 below:

TABLE 26

```
<?xml version=“1.0” encoding=“UTF-8” standalone=“yes” ?>
      <PROTOCOL name=‘Heartbeat’>
      <INITFILE module=‘Heartbeat’>
    <NAMEVALUEPAIR name=‘Channel’ value=‘#’ />
    </ INITFILE>
    </PROTOCOL>
```

The supported channels are as follows as shown in Table 27 below.

TABLE 27

| | | |
|---|---|---|
| Channel 3 | Local | Server |
| Channel 4 | Internet | Server |
| Channel 5 | Receiver | |
| Channel 6 | Browser | |

The Heartbeat initialization file can contain multiple channels if the host is supporting multiple features. Such as Local Server and Internet Server shown in Table 28 below.

TABLE 28

| | | |
|---|---|---|
| Name | Parameters | Action |

AudioContentList Config Interface

| | | |
|---|---|---|
| ListContent | N/A | Return message with all of the content |
| | | currently available across all discovered host |
| | | PCs. |
| ListHosts | N/A | Return message will all hosts server |
| | | hosts currently available. |
| ListVirtualRoots | Host | Return message with all virtual roots |
| | | accessible on the given host. |
| Rescan | N/A | Rescan all hosts for new content. |
| Rescan | Host | Rescan host for new content. |
| Rescan | Host | Rescan host specific virtual root for |
| | VirtualRoot | new content. |

AudioContentList Event Interface

| | | |
|---|---|---|
| AddHosts | Host [, Host, Host, . . . ] | Send SERVER_EVENT and |
| | | CONTENT_EVENT to |
| | | AudioControlSynchronous for new servers. |
| RemoveHosts | Host [, Host, Host, . . . ] | Send SERVER_EVENT and |
| | | CONTENT_EVENT to |
| | | AudioControlSynchronous for removed servers. |

AudioReceiverList Config Interface

| | | |
|---|---|---|
| ListReceivers | N/A | Return message with all of the |
| | | discovered receivers. |

AudioReceiverList Event Interface

| | | |
|---|---|---|
| AddHosts | Host [, Host, Host, . . . ] | Send RECEIVER_EVENT to |
| | | AudioControlSynchronous for new servers. |
| RemoveHosts | Host [, Host, Host, . . . ] | Send RECEIVER_EVENT to |
| | | AudioControlSynchronous for removed servers. |

FileCrawler Config Interface

| | | |
|---|---|---|
| ListFiles | Root | Return message with all of the files |
| | Extension | under the virtual root directory that match the |
| | | given extension. |

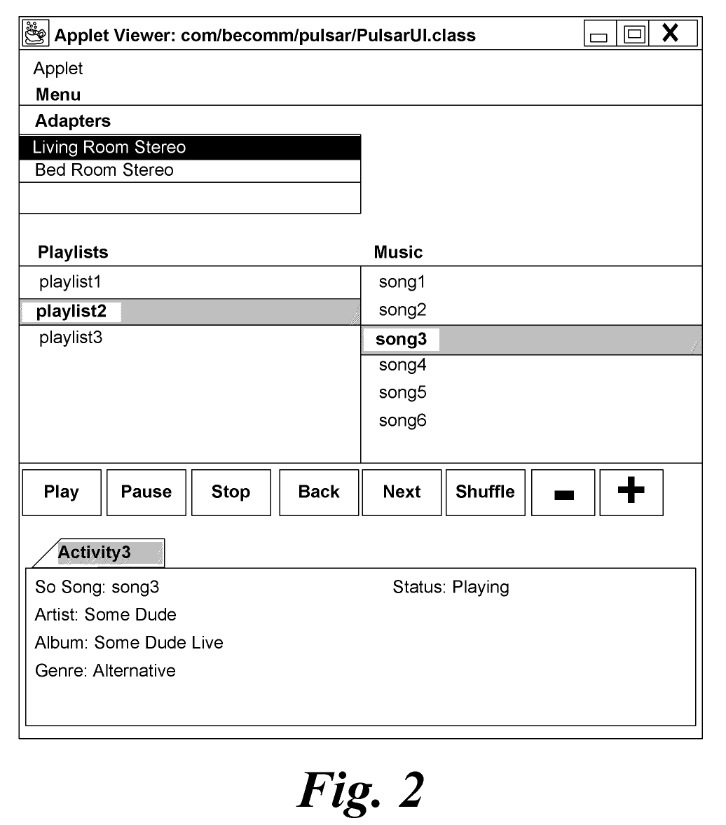

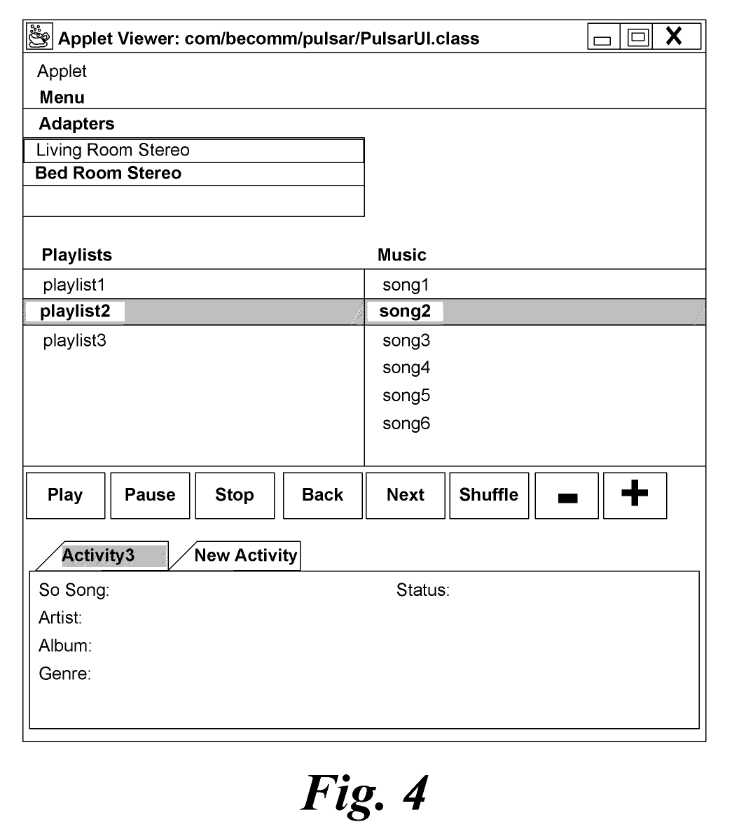

FIGS. 2-4 illustrate images that represents three screen shots from an early version of BeComm's Audio Browser. The Audio Browser allows someone to control multiple audio devices and access all of the audio data on those devices.

FIG. 2 illustrates a first screen shot image that shows the layout of the Audio Browser. A song titled “song3” is currently playing on the “Living Room Stereo”. The Audio Browser should follow along a playlist by highlighting the currently playing song.

Bed Room Stereo is currently not in use and can be added simply by clicking on it. This will cause music to start playing in the Bed Room that was already playing in the Living Room. Removing an Audio player is also simply done by mouse click.

A new song or playlist that could be switched at any point by double clicking on one as shown in FIG. 2.

Different audio can play on different adapters at the same time. This is done by clicking on the + sign on the far right of the button panel. Now a new audio session is created.

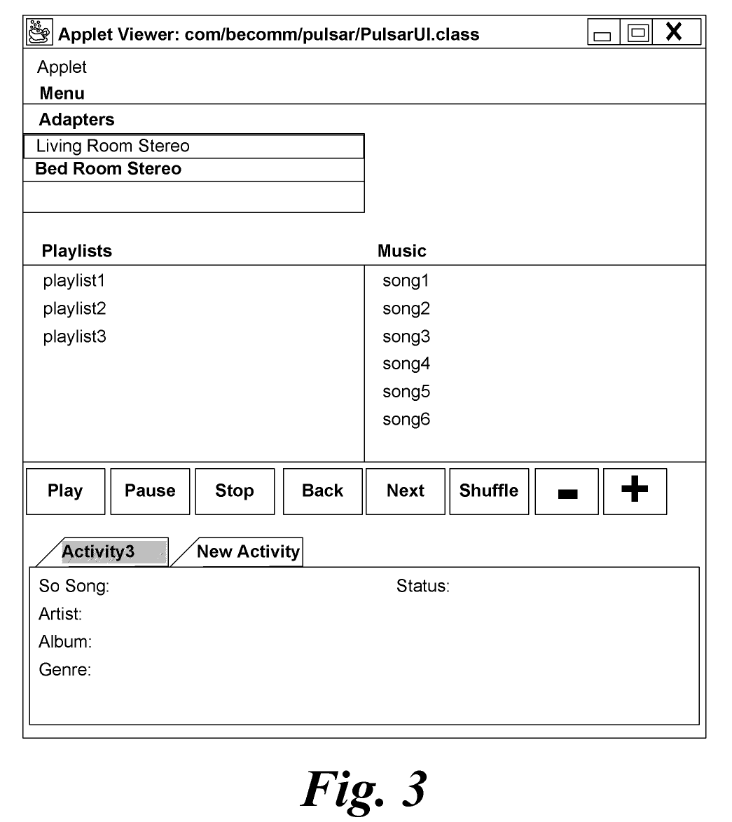

FIG. 3 presents a second screen shot image that illustrates how the user picks a song to start playing music, selects any set of the available adapters (currently light gray represents adapters in use), and hits the play button.

This screen shows the Audio Browsers state before the play button is pressed. When it is song2 will start playing in the Bed Room.

AudioStream Source Events. This document is presented to clearly specify the events generated by AudioStreamSource (ASS). Where the Component Communication document is flexible, this document is slightly more rigid specification to be used for implementation of the ASS events, specifying likely order (comparison of Real and WMA needs to be done) and exact message contents. Note that buffering can take place at any time, except while stopped with no outstanding commands.

For a standard open-play scenario of an mp3 format file, following are the events generated by the AudioStreamSource protocol shown in Tables 29-31 below, in order:

TABLE 29

[Open command issued ]
<?xml version=“1.0” encoding=“UTF-8” standalone=“yes” ?>
<PLAYBACK_EVENT version=“ 1.0”>
<LENGTH value=“ 0” units=“milliseconds” />
</ PLAYBACK_EVENT>

Not implemented yet:

TABLE 30

| | |
|---|---|
| <?xml version=“1.0” | encoding=“UTF-8” standalone=“yes” |
| ?> | |
| <PLAYBACK_EVENT | version=“1.0” > |
| <TITLE | name=“Title” /> |
| <ARTIST | name=“Artist” /> |
| <ALBUM | name=“Album” /> |
| <GENRE | name=“ Genre” /> |
| </ PLAYBACK_EVENT> | |
| <?xml version=“1.0” | encoding=“UTF-8” standalone=“yes” |
| ?> | |
| <PLAYBACK_EVENT | version=“1.0” > |
| <STATE value | = Stopped” /> |
| </ PLAYBACK_EVENT> | |
| [Play command Issued ] | |
| <?xml version=“1.0” | encoding=“UTF-8” standalone=“yes” |
| ?> | |
| <PLAYBACK_EVENT | version=“1.0” > |
| <STATE | value = “Playing” /> |
| </PLAYBACK_EVENT> | |

Net congestion:

TABLE 31

| | |
|---|---|
| <?xml version=“1.0” | encoding=“UTF-8” standalone=“yes” |
| ?> | |
| <PLAYBACK_EVENT | version=“1.0” > |
| <STATE | value = “Buffering” /> |
| <PROGRESS | value=“ 0-100” units=“percentage” /> |
| </ PLAYBACK_EVENT> | |
| [song plays to completion] | |
| <?xml version=“1.0” | encoding=“UTF-8” standalone=“yes” |
| ?> | |
| <PLAYBACK_EVENT | version=“1.0” > |
| <STATE | value = “Stopped” /> |
| </ PLAYBACK_EVENT> | |

For a standard seek scenario of an mp3 format file, following are the events generated by the AudioStreamSource protocol shown in Table 32 below, in order:

TABLE 32

| | |
|---|---|
| [Seek command issued ] | |
| Seek: | |
| <?xml version=“1.0” | encoding=“UTF-8” standalone=“yes” |
| ?> | |
| <PLAYBACK_EVENT | version=“1.0” > |
| <STATE | value = “Buffering” /> |
| <PROGRESS | value=“ 0-100” units=“percentage” /> |
| </PLAYBACK_EVENT> | |
| <?xml version=“1.0” | encoding=“UTF-8” standalone=“yes” |
| ?> | |
| <PLAYBACK_EVENT | version=“1.0” > |
| <STATE | value = “Playing” /> |
| </ PLAYBACK_EVENT> | |

For a standard pause of a live stream scenario of an mp3 format file, following are the events generated by the AudioStreamSource protocol shown in Tables 33 and 34 below, in order:

TABLE 33

| | |
|---|---|
| [Pause command issued ] | |
| <?xml version=“1.0” | encoding=“UTF-8” standalone=“yes” |
| ?> | |
| <PLAYBACK_EVENT | version=“1.0” > |
| <STATE | value = “Paused” /> |
| </PLAYBACK_EVENT> | |
| [Resume command issued ] | |

Resume live stream:

TABLE 34

| | |
|---|---|
| <?xml version=“1.0” | encoding=“UTF-8” standalone=“yes” |
| ?> | |
| <PLAYBACK_EVENT | version=“1.0” > |
| <STATE | value = “Buffering” /> |
| <PROGRESS | value=“ 0-100” units=“percentage” /> |
| </ PLAYBACK_EVENT> | |
| <?xml version=“1.0” | encoding=“UTF-8” standalone=“yes” |
| ?> | |
| <PLAYBACK_EVENT | version=“1.0” > |
| <STATE | value = “Playing” /> |
| </ PLAYBACK_EVENT> | |

For a standard stop-play scenario of an mp3 format file, following are the events generated by the AudioStreamSource protocol shown in Tables 35 and 36 below, in order:

TABLE 35

| | |
|---|---|
| [Stop command issued] | |
| <?xml version=“1.0” | encoding=“UTF-8” standalone=“yes” |
| ?> | |
| <PLAYBACK_EVENT | version=“1.0” > |
| <STATE | value = “Stopped” /> |
| </ PLAYBACK_EVENT> | |
| [Play command issued] | |

Net congestion:

TABLE 36

| | |
|---|---|
| <?xml version=“1.0” | encoding=“UTF-8” standalone=“yes” |
| ?> | |
| <PLAYBACK_EVENT | version=“1.0” > |
| <STATE | value = “Buffering” /> |
| <PROGRESS | value=“ 0-100” units=“percentage” /> |
| </ PLAYBACK_EVENT> | |
| <?xml version=“1.0” | encoding=“UTF-8” standalone=“yes” |
| ?> | |
| <PLAYBACK_EVENT | version=“1.0” > |
| <STATE | value = “Playing” /> |
| </ PLAYBACK_EVENT> | |

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

I claim:

1. An audio server system for streaming audio content, comprising:
an audio switch that receives commands from an audio control component and sends commands to an audio stream source, that receives events from an audio stream source and sends events to an audio browse list component, and that controls the switching of audio from the audio stream source to one or more receivers; and
an audio control component that receives commands from an audio control synchronous component and sends commands to the audio switch.
